(19) United States
(12) Patent Application Publication
(10) Pub. No.: US 2026/0233551 A1
(43) Pub. Date: Aug. 13, 2026

(54) ROLLABLE PEN

(71) Applicant: Han Kiel LEE, Seoul (KR)

(72) Inventor: Han Kiel LEE, Seoul (KR)

(21) Appl. No.: 18/706,392

(22) PCT Filed: Oct. 14, 2022
(86) PCT No.: PCT/KR2022/015616

§ 371 Date: Apr. 21, 2026

(30) Foreign Application Priority Data
Nov. 4, 2021 (KR) 10-2021-0150494
Apr. 26, 2022 (KR) 10-2022-0051340

(51) Int. Cl. B43K 24/02; B43K 23/00

(52) U.S. Cl. CPC B43K 24/02; B43K 23/001

(57) ABSTRACT

The present invention relates to a pen that is easy to carry, and in particular, to a rollable pen that is unfolded and stored in a wallet in the form of a card when being carried and is used by rolling the pen that is in the form of a card and thereby changing same into a pen shape.

### TECHNICAL FIELD

The present invention relates to a portable pen, specifically a rollable pen configured to be carried in a wallet in a flat, card-like form and transformed into a cylindrical pen shape for use when needed.

### BACKGROUND ART

In daily life, there are often urgent needs to take notes or sign documents.

However, if writing instruments are not available or cannot be carried, tasks often depend on memory, leading to inefficient work progression.

Despite being essential items to carry, writing instruments are inconvenient to carry and are often lost.

### SUMMARY

The present invention was devised to solve the aforementioned problems; it aims to provide a rollable pen that can be stored in a wallet in card form when going out and quickly transformed into a cylindrical pen shape for taking notes or signing when needed.

To achieve the objectives, the rollable pen according to the present invention includes an upper member in which the pen is slidably stored, a predetermined number of connecting members that are consecutively and parallelly attached to one side of the upper member, and a lower member parallelly attached to the side end of the connected connecting members. Each member is attached via rotational fastening means allowing rotation at a predetermined angle with respect to the neighboring members, thus enabling each member forming a card shape to be rolled so that the connecting member forms a polygonal column, with the upper member and the lower member fastened within the polygonal column by fastening means, and the pen protrudes, transforming from card form to pen form.

Additionally, it is preferable that each connecting member includes a slide link that is attachable longitudinally to the connecting member and a pen support molded in a triangular shape at the end of the slide link. This configuration allows the pen support to protrude in conjunction with the pen, radially contacting and supporting the pen.

Furthermore, it is advisable to form a pen groove on the surface of the pen support that contacts the pen, thereby stabilizing the support of the pen.

Moreover, the fastening means that fasten and fix the upper member and the lower member inside the polygonal column may have a space to accommodate a holder within the upper member, comprising a protruding pen part and a pen part storage groove formed in the lower member as a groove, thus allowing the pen part to be inserted and fixed into the pen part storage groove.

Also, the rotational fastening means may be designed such that sleeves formed on the sides of each member align on the same axis, and a shaft inserted into the sleeve allows the members to rotate.

Additionally, the sleeve formed on the side of the slide link may guide the sliding motion of the slide link by having the shaft inserted into it.

Moreover, the pen support equipped with side protrusions may be attached to the slide link via a hinge, and a link equipped with guide protrusions may cover and fix the pen support, allowing the pen support to protrude from the connecting member and rotate around the hinge as it contacts the guide protrusion of the link.

A latch molded with a polygonal cross-section may be inserted into the shaft, making contact with the sides of the members attached to the shaft, maintaining the shapes of both the card and pen forms.

The fastening means that fasten and fix the upper member and the lower member inside the polygonal column may be designed so that the magnet inside the housing of the upper member and the magnet inside the housing of the lower member are magnetically attached.

As configured above, the present invention can be stored in a wallet in a flat, card-like form for everyday carry, and when needed, it can be easily retrieved and rolled into a cylindrical pen shape for use.

Additionally, when transformed into a conventional pen shape by rolling, the pen provides a writing experience similar to that of a regular pen, as the body of the pen does not

### BRIEF DESCRIPTION OF DRAWINGS

FIG. 1 is a perspective view showing a rollable pen in card form according to an embodiment of the present invention.

FIG. 2 is an exploded perspective view showing the disassembled covers of each member constituting the rollable pen in card form according to an embodiment of the invention.

FIG. 3 is a plan view showing the state of the disassembled covers of each member constituting the rollable pen in card form according to an embodiment of the invention.

FIG. 4 is an exploded perspective view showing the lower member constituting the rollable pen according to an embodiment of the invention.

FIG. 5 is an exploded perspective view showing the connecting member constituting the rollable pen according to an embodiment of the invention.

FIG. 6 is a perspective view showing the state where the slide link and link are coupled to the housing in the connecting member from FIG. 5.

FIG. 7 is an exploded perspective view showing the upper member constituting the rollable pen according to an embodiment of the invention.

FIG. 8 is a perspective view showing the state where the slide link and the upper member link are coupled to the housing in the upper member from FIG. 7.

FIG. 9 is a perspective view showing the state where the upper member, connecting member, and lower member are combined according to an embodiment of the invention.

FIG. 10 and FIG. 11 are perspective and side views showing the state where the holder is pushed to protrude the pen and pen support from the rollable pen in card form.

FIG. 12 is a cross-sectional view along line A-A in FIG. 1.

FIG. 13 and FIG. 14 are perspective and frontal views showing the state of transforming the rollable pen from a card form to a pen form according to an embodiment of the invention.

FIG. 15 is a frontal view showing the state where the rollable pen in card form is completely rolled into a pen form according to an embodiment of the invention.

FIG. 16 is a rear view showing the state where the rollable pen in card form is completely rolled into a pen form according to an embodiment of the invention.

FIG. 17 is a perspective view showing the state where the rollable pen in card form is completely rolled into a pen form according to an embodiment of the invention.

FIG. 18 is a perspective view showing a rollable pen in card form according to another embodiment of the invention.

FIG. 19 and FIG. 20 are exploded perspective views showing the rollable pen in card form according to another embodiment of the invention.

FIG. 21 is a plan perspective view showing the state where the middle member is pushed to protrude the pen and pen support according to another embodiment of the invention.

FIG. 22 is an underside perspective view showing the state where the middle member is pushed to protrude the pen and pen support according to another embodiment of the invention.

FIG. 23 is a frontal view showing the state of transforming the rollable pen into a pen form by rolling according to another embodiment of the invention.

FIG. 24 is a perspective view showing the state of the rollable pen transformed into a pen form by rolling according to another embodiment of the invention.

FIG. 25 is a perspective view showing a rollable pen in card form according to yet another embodiment of the invention.

FIG. 26 is a perspective view showing the upper member constituting the rollable pen in card form according to yet another embodiment of the invention.

FIG. 27 is an exploded perspective view showing the upper member constituting the rollable pen in card form according to yet another embodiment of the invention.

FIG. 28 is a perspective view showing the connecting member constituting the rollable pen in card form according to yet another embodiment of the invention.

FIG. 29 is an exploded perspective view showing the connecting member constituting the rollable pen in card form according to yet another embodiment of the invention.

FIG. 30 is an exploded perspective view showing the slide link constituting the connecting member according to yet another embodiment of the invention.

FIG. 31 and FIG. 32 are sectional views of the connecting member showing the process of the pen support protruding and rotating in sequence according to yet another embodiment of the invention.

FIG. 33 is an exploded perspective view showing the lower member constituting the rollable pen in card form according to yet another embodiment of the invention.

FIG. 34 is a plan view showing the state where the upper member and the connecting member are fastened according to yet another embodiment of the invention.

FIG. 35 is a plan view showing the state where the connecting members are fastened together according to yet another embodiment of the invention.

FIG. 36 is a plan view showing the state where the connecting member and the lower member are fastened according to yet another embodiment of the invention.

FIG. 37, FIG. 38 and FIG. 39 are perspective views sequentially showing the process of transforming the rollable pen from card form to pen form according to yet another embodiment of the invention.

### DESCRIPTION OF REFERENCE NUMERALS

100: Rollable Pen
110: Lower Member
1110: Housing
1111: Pen Part Storage Groove
1112: Coupling Protrusion Storage Part
1113: Catching Protrusion
1114: Guide Protrusion
1115: Link Storage Part
1116: Catching Protrusion
1117: Sleeve
1118: Magnet
120: Connecting Member
1210: Housing
1211: Slide Link Storage Part
1212: Entrance
1213: Entrance Wall
1214: Guide Protrusion
1215: Link Storage Part
1216: Catching Protrusion
1217: Shaft
1218: Sleeve
1220: Slide Link
12201: Sleeve
12202: Hinge Groove
12203: Stopper
1221: Pen Support
12211: Hinge
12212: Side Protrusion
12213: First Surface
12214: Second Surface
12215: Joint Section
1222: Pen Groove
1223: Coupling Protrusion Storage Part
1224: Catching Protrusion
1225: Guide Protrusion Groove
1226: Displacement Groove
1227: Flange
1228: Elastic Protrusion
1229: Coupling Protrusion
1230: Link
1231: Flange
1232: Elastic Protrusion
1233: Sleeve
1234: Pen Support Insertion Groove
1235: Guide Protrusion
1240: Cover
1241: Pressing Protrusion
1251: Sleeve
130: Upper Member
1310: Housing
1311: Slide Link Storage Part
1312: Entrance Wall
1313: Guide Protrusion
1314: Link Storage Part
1315: Catching Protrusion
1316: Fixing Groove
1317: Sleeve
1320: Holder
1321: Coupling Protrusion
1322: Pen Part Storage Groove Fixing Protrusion
1323: Pen
1324: Fixing Knob
1325: Sleeve
1330: Slide Link
1331: Protrusion Coupling Groove
1332: Guide Protrusion Groove
1333: Coupling Protrusion
1334: Guide Protrusion Groove
1335: Flange
1336: Elastic Protrusion
1340: Upper Member Link
1341: Flange
1342: Elastic Protrusion
1343: Protrusion
1350: Cover
1351: Pen Part
1360: Magnet
141: Latch

### DETAILED DECRIPTION OF EMBODIMENTS

The rollable pen of the present invention includes:
an upper member 130 in which the pen 1323 is stored to allow slide movement;
a connecting member 120 that is fixedly attached in parallel and continuously on one side of the upper member 130 in a predetermined number;
a lower member 110 that is fixedly attached in parallel to the side end of the continuously connected connecting members 120; and
rotating fastening means for connecting the members 110, 120, 130 such that each member can be rotated at a predetermined angle with respect to the neighboring member 110, 120, 130.

By this configuration, each member 110, 120, 130, forming a card shape, can be rolled so that the connecting member 120 forms a polygonal column, and the upper member 130 and the lower member 110 are fastened inside the polygonal column using fastening means, allowing the pen 1323 to protrude and transform from a card form to a pen form.

Below, a preferred embodiment of the present invention is described in detail with reference to the accompanying drawings, where the same reference numerals in the drawings denote the same components.

When any component in the detailed description or the claims of the invention is said to “comprise” another component, unless explicitly stated otherwise, it is not limited to those components only and should be understood to potentially include other components.

Terms such as “upper”, “lower”, “bottom”, “front”, “rear”, “below” used in this specification are for ease of description and refer to the orientation of components as depicted in the drawings.

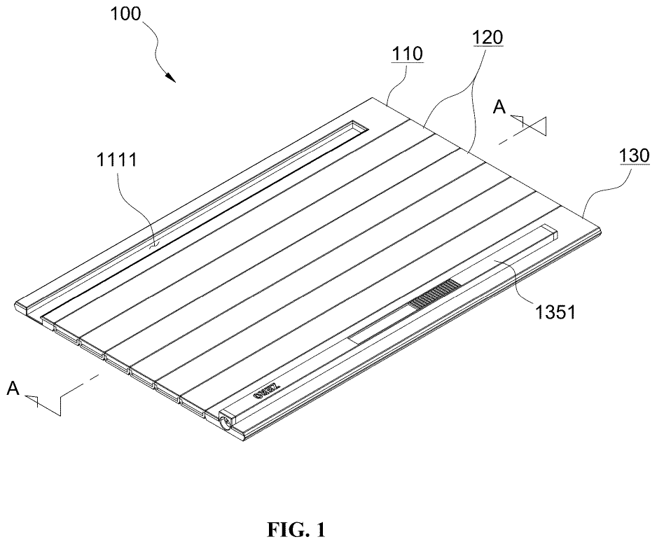

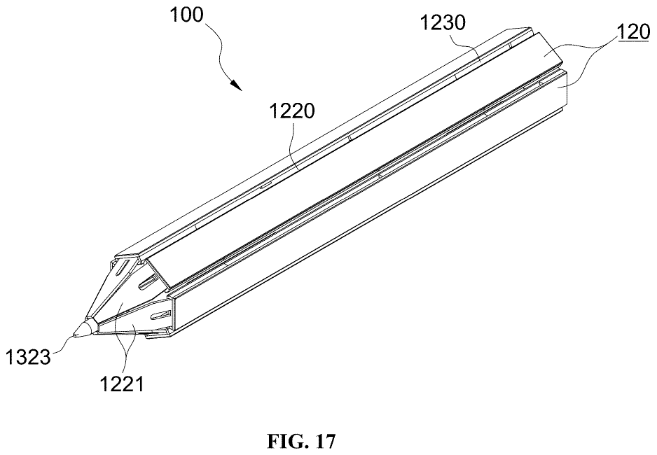

A rollable pen 100 according to an embodiment of the invention, as shown in FIG. 1, is configured to be carried in the credit card storage section of a wallet in card form and can be easily used by rolling the card-shaped pen into a conventional pen form as shown in FIG. 17 when a pen is needed.

For this purpose, as shown in FIGS. 1 to 3, six connecting members 120 are continuously attached in a horizontal direction, and a lower member 110 and an upper member 130 are attached on each side of the continuously attached connecting members 120.

The lower member 110, as shown in FIG. 4, comprises a housing 1110 and a cover 1120 that are attached together.

A pen storage groove 1111 in the form of a long groove is formed on the upper surface of the housing 1110, and on one side of the pen storage groove 1111, towards the direction where the connecting member 120 described later is attached, a coupling protrusion storage part 1112 and a link storage part 1115 are continuously formed in the form of grooves.

In the coupling protrusion storage part 1112, a guide protrusion 1114 protrudes, and catching protrusions 1113 are formed protruding on both sides of the side end of the coupling protrusion storage part 1112.

Similarly to the coupling protrusion storage part 1112, catching protrusions 1116 are also formed protruding on both sides of the side end of the link storage part 1115.

In the link storage part 1115, a lower member link 1130 is coupled and stored. As shown in FIG. 4, a pair of flanges 1131 is formed on both sides of the body of the lower member link 1130. On one of the flanges 1131, a protrusion 1133 is formed bent and extending inwardly from the body, and on the other flange 1131, an inclined elastic protrusion 1132 is formed inwardly.

The lower member link 1130, as configured above, is inserted and coupled into the link storage part 1115 such that the elastic protrusion 1132 contacts the catching protrusion 1116 of the link storage part 1115.

A cover 1120 is attached to the upper part of the housing 1110 of the lower member 110 as configured above, covering the coupling protrusion storage part 1112 and the link storage part 1115. By cutting part of the cover 1120, even when the cover 1120 is attached, the pen storage groove 1111 of the housing 1110 is exposed.

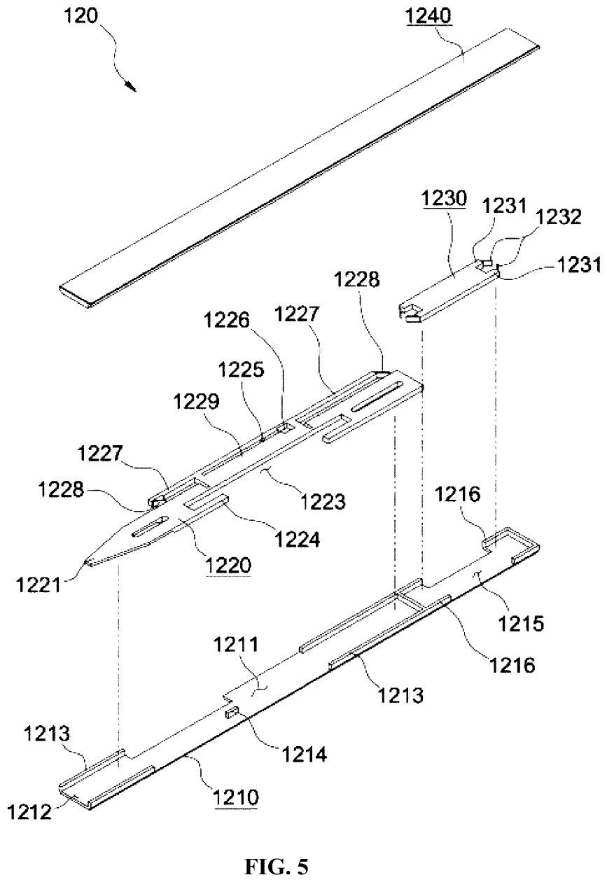

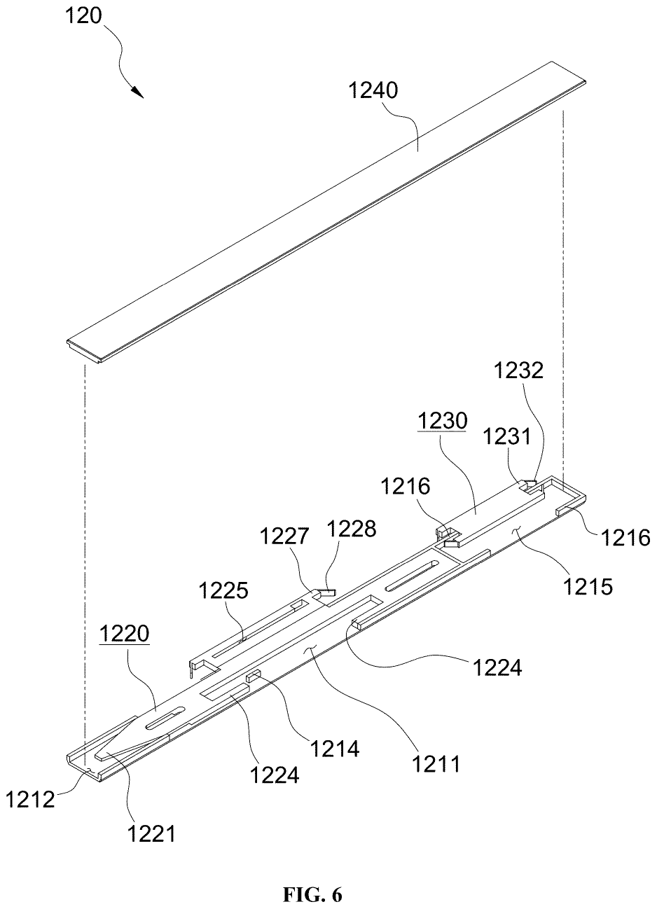

The connecting member 120 is composed of a housing 1210, a slide link 1220 and a link 1230 that are coupled and stored with the housing 1210, and a cover 1240 that is attached to cover the top of the housing 1210, as shown in FIGS. 5 and 6.

In the housing 1210, a slide link storage part 1211 is formed in the form of a groove by a protruding entrance wall 1213, and a link storage part 1215 is formed in the form of a groove by a protruding catching protrusion 1216.

The slide link storage part 1211 has its central portion between the entrance walls 1213 opened, and a guide protrusion 1214 is formed protruding in the slide link storage part 1211. An entrance 1212 is also formed at the front of the slide link storage part 1211.

The link storage part 1215 is formed with the central parts of its side catching protrusions 1216 open.

A slide link 1220 is inserted and coupled into the slide link storage part 1211. As shown in FIG. 5, the slide link 1220 includes a perforated coupling protrusion storage part 1223 formed in the body, and catching protrusions 1224 are formed at both ends on one side of the coupling protrusion storage part 1223, extending from the body.

Opposite to where the coupling protrusion storage part 1223 is formed, a coupling protrusion 1229 is created, and flanges 1227 extend from both sides of the coupling protrusion 1229, with inclined elastic protrusions 1228 formed at the ends of these flanges towards the body direction.

The coupling protrusion 1229 features a slot in the form of a long hole forming a guide protrusion groove 1225, and the end of the guide protrusion groove 1225 is bent and extended in the direction of the body to form a displacement groove 1226.

The body front of the slide link 1220 extends in a triangular shape to form a pen support 1221.

As configured, the slide link 1220 is inserted into the slide link storage part 1211 of the housing 1210 as shown in FIG. 6, with the pen support 1221 facing towards the entrance 1212.

When the slide link 1220 is inserted into the slide link storage part 1211 of the housing 1210, as shown in FIG. 6, the guide protrusion 1214 of the housing 1210 is positioned at the coupling protrusion storage part 1223 of the slide link 1220, and the coupling protrusion 1229 of the slide link 1220 protrudes laterally through the open section between the entrance walls 1213 of the slide link storage part 1211.

Alink 1230 is inserted and coupled into the link storage part 1215 of the housing 1210. As shown in FIG. 5, the body of the link 1230 extends on both sides, forming a pair of flanges 1231, and each flange 1231 has an inclined elastic protrusion 1232 formed towards the inside of the body.

When the link 1230, as configured above, is inserted into the link storage part 1215 of the housing 1210, as shown in FIG. 6, the body of the link 1230 is positioned between the catching protrusions 1216, and the catching protrusions 1216 are situated between the elastic protrusions 1232 of the link 1230.

After inserting and coupling the slide link 1220 and the link 1230 into the housing 1210 as described, a cover 1240 is attached to the top of the housing 1210 to form the connecting member 120.

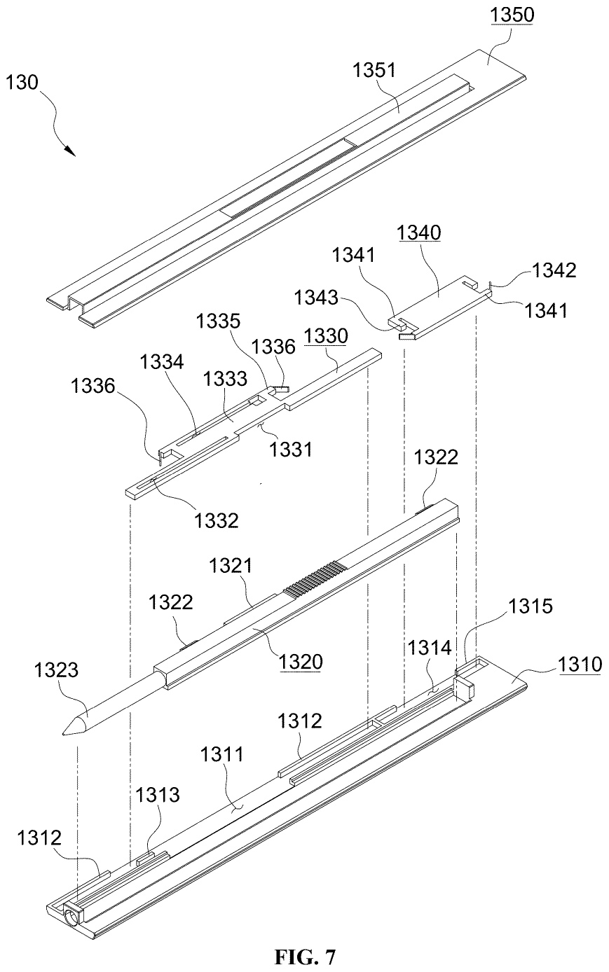

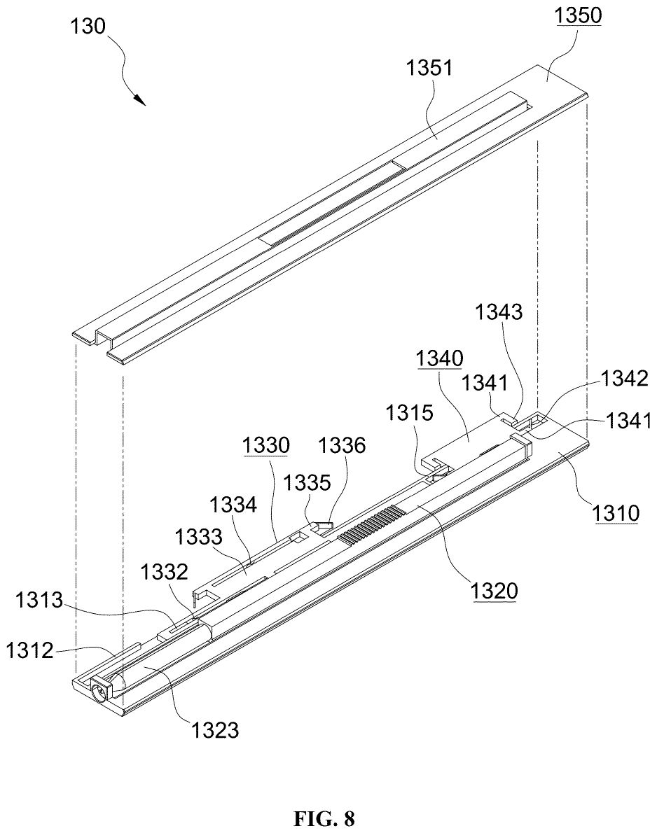

The upper member 130, as shown in FIG. 7, consists of a housing 1310, a slide link 1330 and an upper member link 1340 that are coupled and stored within the housing 1310, a holder 1320 that accommodates the pen 1323 and is coupled to the housing 1310, and a cover 1350 that is attached to cover the housing 1310.

In the housing 1310, a slide link storage part 1311 is formed in the shape of a groove by a protruding entrance wall 1312, and a link storage part 1314 is formed in the shape of a groove by a protruding catching protrusion 1315.

The slide link storage part 1311 has its central part between the entrance walls 1312 opened, and a guide protrusion 1313 is formed protruding in the slide link storage part 1311.

A slide link 1330 is inserted and coupled into the slide link storage part 1311. As shown in FIG. 7, the slide link 1330 has a protrusion coupling groove 1331 formed, which is perforated to open laterally, and a long-hole shaped guide protrusion groove 1332 is also formed in the body.

On the side opposite to the protrusion coupling groove 1331 of the slide link 1330, a coupling protrusion 1333 is formed. Flanges 1335 are formed extending from both ends of the coupling protrusion 1333, and at the ends of these flanges 1335, inclined elastic protrusions 1336 are formed towards the body direction.

Additionally, a guide protrusion groove 1334 is formed in the coupling protrusion 1333 of the slide link 1330 in the form of a long hole.

When the slide link 1330, as configured, is inserted and coupled into the slide link storage part 1311 of the housing 1310, the guide protrusion 1313 of the slide link storage part 1311 inserts into the guide protrusion groove 1332 of the slide link 1330, and the coupling protrusion 1333 of the slide link 1330 protrudes laterally from the slide link storage part 1311.

An upper member link 1340 is inserted and coupled into the link storage part 1314 of the housing 1310. As shown in FIG. 7, the body of the upper member link 1340 extends on both sides to form a pair of flanges 1341. A protrusion 1343 is formed on one flange 1341 by bending and extending inwardly from the body, and on the other flange 1341, an inclined elastic protrusion 1342 is formed towards the inside of the body.

The upper member link 1340, as configured, is inserted into the link storage part 1314 such that the elastic protrusion 1342 contacts the catching protrusion 1315 of the link storage part 1314.

On one side of the slide link 1330, a holder 1320 equipped with a pen 1323 is attached to the housing 1310. The holder 1320 is coupled to the housing 1310 in such a way that the coupling protrusion 1321, protruding laterally from the holder 1320, inserts into the protrusion coupling groove 1331 of the slide link 1330.

As configured, a cover 1350 is attached to the top of the housing 1310, into which the slide link 1330, holder 1320, and upper member link 1340 have been inserted and coupled. The cover 1350 features a pen part 1351 protruding upward, creating space inside the cover 1350 for the insertion of the pen 1323 and the holder 1320. When the cover 1350 is attached to the housing 1310, the holder 1320 and the pen 1323 are stored inside the pen part 1351 of the cover 1350.

The lower member 110, connecting member 120, and upper member 130 are consecutively connected as configured.

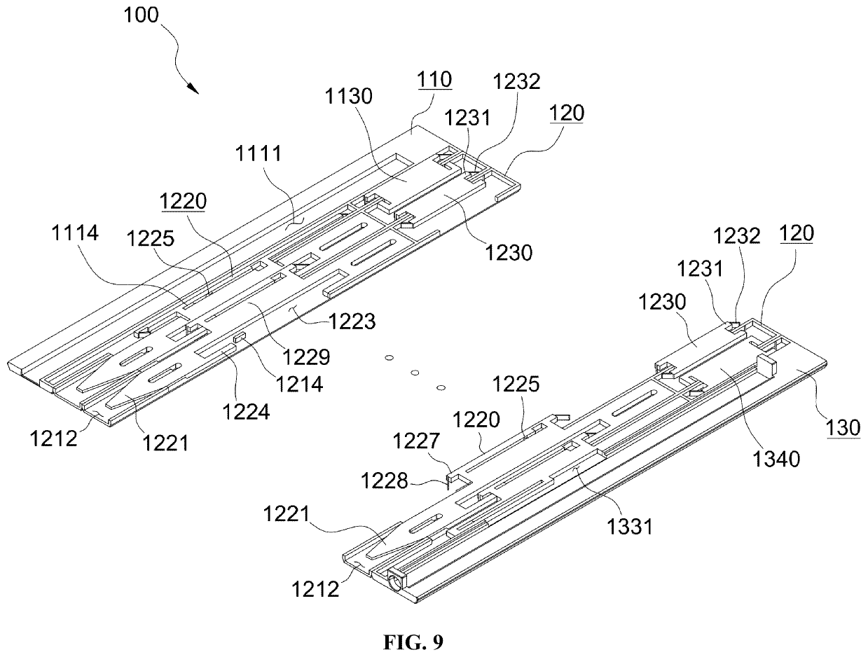

As shown in FIGS. 1 to 3 and FIG. 9, the connecting member 120 is coupled to one side of the upper member 130. The coupling protrusion 1333 of the slide link 1330 of the upper member 130 is inserted into the coupling protrusion storage part 1223 of the slide link 1220 of the connecting member 120. The catching protrusions 1224 on both sides of the coupling protrusion storage part 1223 of the connecting member 120 insert between the body and the flanges 1335 of the slide link 1330 of the upper member 130, thus connecting the upper member 130 and the connecting member 120.

At this time, the guide protrusion 1214 protruding from the slide link storage part 1211 of the connecting member 120 inserts into the guide protrusion groove 1334 of the upper member 130's slide link 1330.

Moreover, the catching protrusion 1216 formed in the link storage part 1215 of the connecting member 120 inserts between the flanges 1341 of the upper member link 1340 of the upper member 130, thereby connecting the upper member 130 and the connecting member 120.

As such, the upper member 130 is connected to the connecting member 120, and then five additional connecting members 120 are consecutively connected to this connecting member 120.

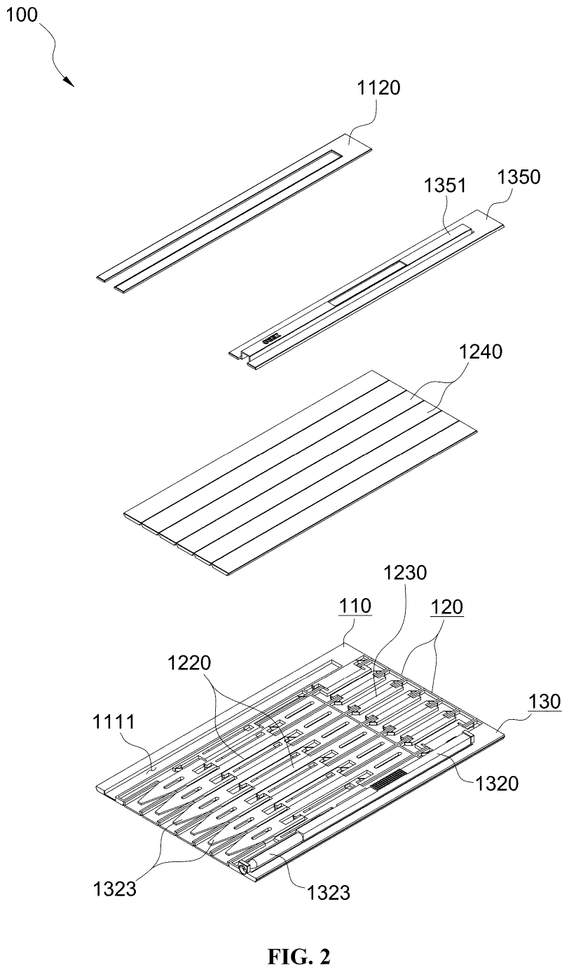

The connection between the connecting member 120 and another connecting member 120 is made as shown in FIGS. 2, 3, and 9, through the slide links 1220 and links 1230.

The connection between connecting members 120 via the slide link 1220 is accomplished as follows.

The coupling protrusion 1229 of the slide link 1220 protruding from the connecting member 120 towards the upper member 130 (hereafter referred to as “U-connecting member”) is inserted into the coupling protrusion storage part 1223 of the slide link 1220 of the connecting member 120 towards the lower member 110 (hereafter referred to as “D-connecting member”).

When the coupling protrusion 1229 of the U-connecting member slide link 1220 is inserted into the coupling protrusion storage part 1223 of the D-connecting member slide link 1220, the guide protrusion 1214 of the D-connecting member inserts into the guide protrusion groove 1225 of the U-connecting member slide link 1220.

Furthermore, the elastic protrusion 1228 of the U-connecting member slide link 1220 contacts the catching protrusion 1224 of the D-connecting member slide link 1220, thereby elastically securing the U-connecting member to the D-connecting member.

The connection between the connecting members 120 through the link 1230 is accomplished as follows.

The flanges 1231 of the link 1230 and the catching protrusions 1216 of the link storage part 1215 of both the U-connecting member and D-connecting member are inserted between the flanges 1231. The elastic protrusion 1232 of the link 1230 contacts the catching protrusions 1216 of both the U-connecting member and D-connecting member, thereby elastically securing them together.

In such a manner, six connecting members 120 are connected, and the last connecting member 120 is connected to the lower member 110.

As shown in FIGS. 2, 3, and 9, the coupling protrusion 1229 of the slide link 1220 protruding from the last connecting member 120 is inserted into the coupling protrusion storage part 1112 of the lower member 110's housing 1110. At this time, the guide protrusion 1114 of the housing 1110 inserts into the guide protrusion groove 1225 of the slide link 1220, and the elastic protrusion 1228 of the slide link 1220 contacts the catching protrusion 1113, thus elastically securing the lower member 110 to the connecting member 120.

When the lower member 110, the six connecting members 120, and the upper member 130 are connected as described, a rollable pen 100 of credit card size is formed as shown in FIG. 1.

This credit card-sized rollable pen 100 is typically carried in a wallet, and when a writing instrument is needed, it is rolled from its card form into a conventional pen form for use.

Below, the process of transforming from the card form to a conventional pen form is detailed.

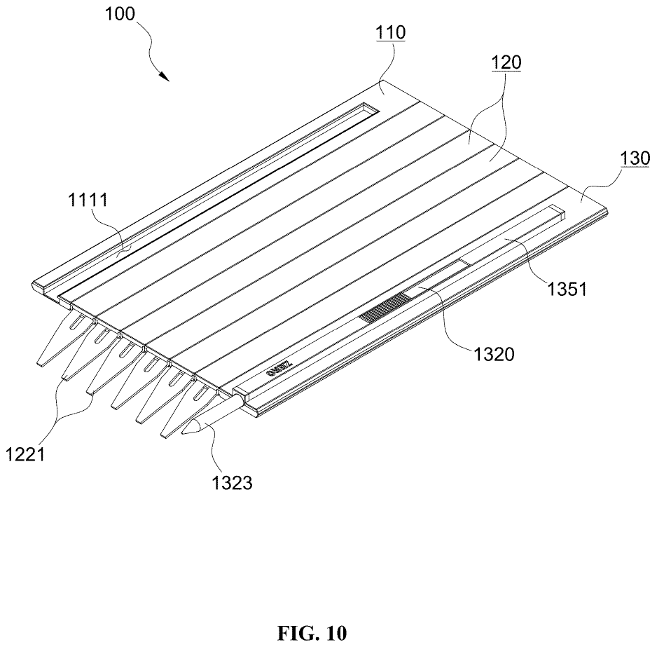

First, as shown in FIG. 10, by pushing the holder 1320 exposed through the pen part 1351 of the upper member 130 forward, the pen supports 1221 within each connecting member 120 protrude through the entrance 1212 formed at the front of the connecting members 120.

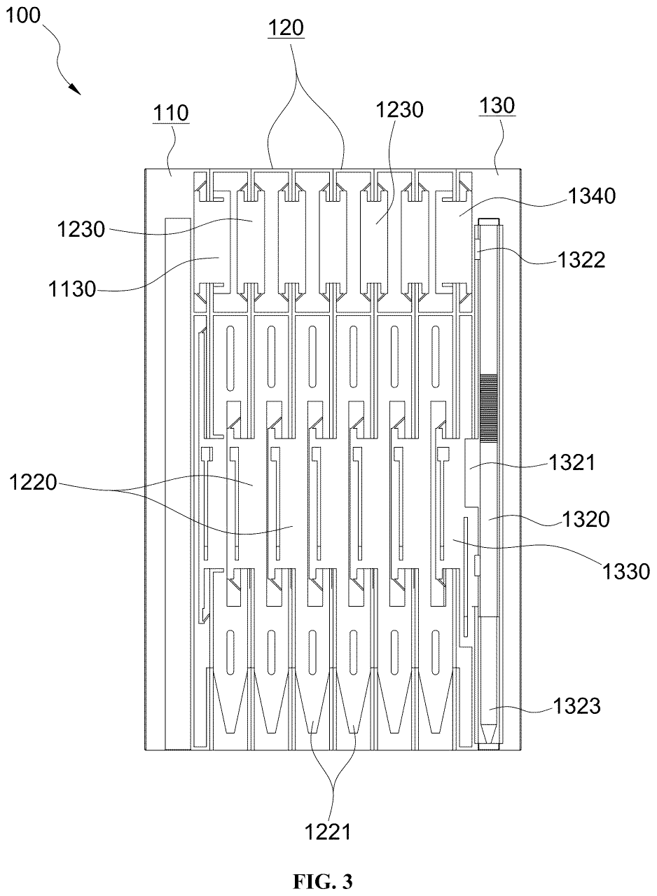

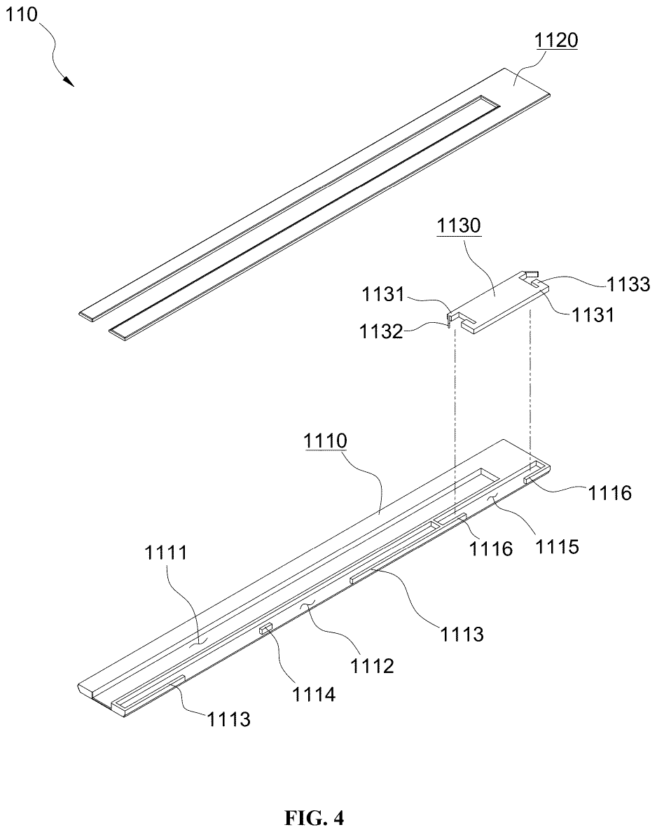

As in FIG. 3, the coupling protrusion 1321 protruding laterally from the holder 1320 is inserted into the coupling protrusion storage part 1223 of the slide link 1220 of the connected upper member 130, and this connecting member 120's slide link 1220's coupling protrusion 1229 is then inserted and coupled into the coupling protrusion storage part 1223 of another slide link 1220 of the next connecting member 120, thus linking the holder 1320 to all the slide links 1220 of the connecting members 120.

Therefore, when the holder 1320 is pushed forward, each connecting member 120's slide link 1220, coupled to the holder 1320, slides in synchronization with the holder 1320, causing the pen supports 1221 at the front of the slide links 1220 to protrude as shown in FIG. 10.

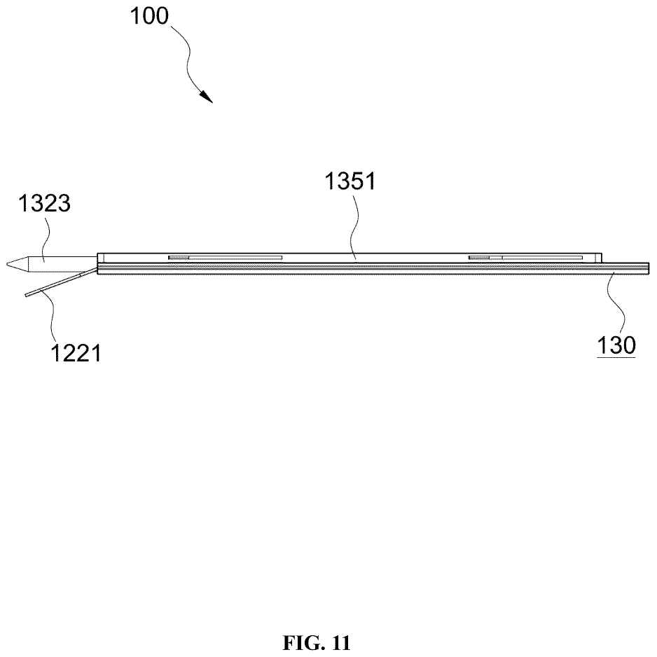

The pen support 1221 is designed to bend downward at a predetermined angle when it protrudes from the connecting member 120, as depicted in FIGS. 10 and 11.

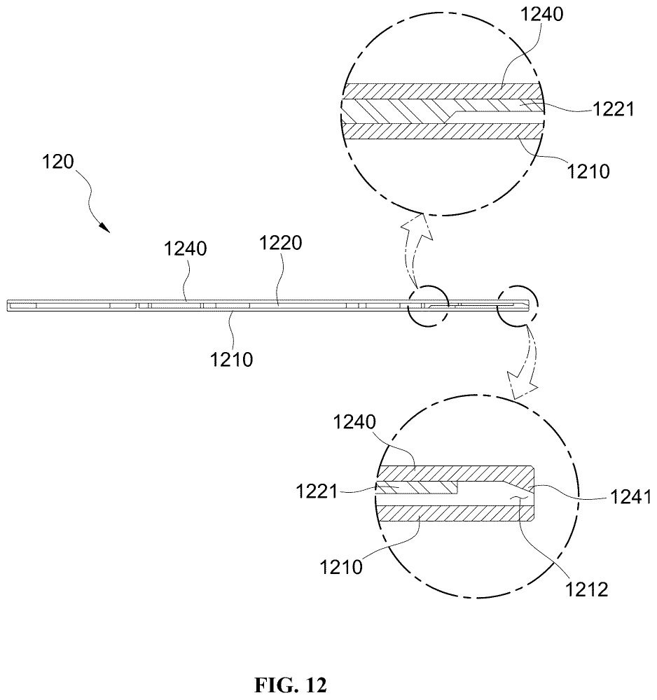

To achieve this, as illustrated in FIGS. 5 and 12, a pressing protrusion 1241 is formed protruding downward at the front of the cover 1240 of the connecting member 120, which bends the protruding pen support 1221 downward at a predetermined angle when it protrudes.

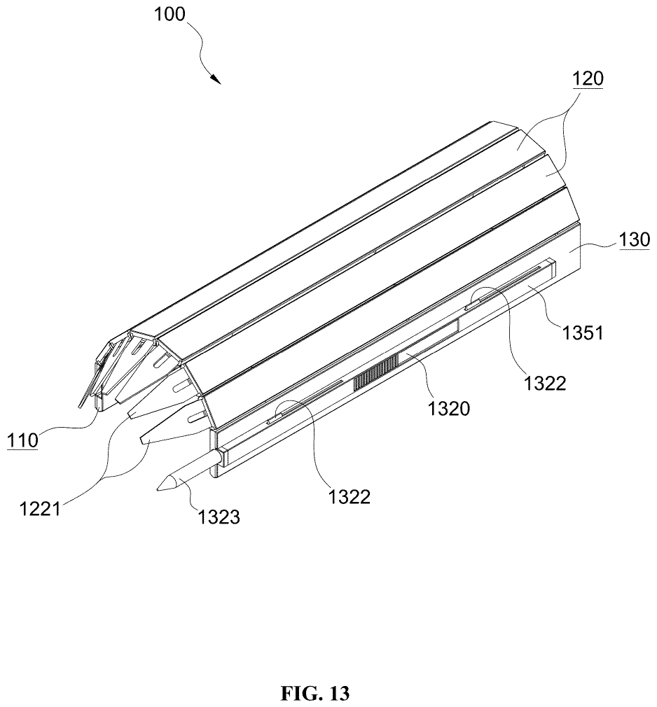

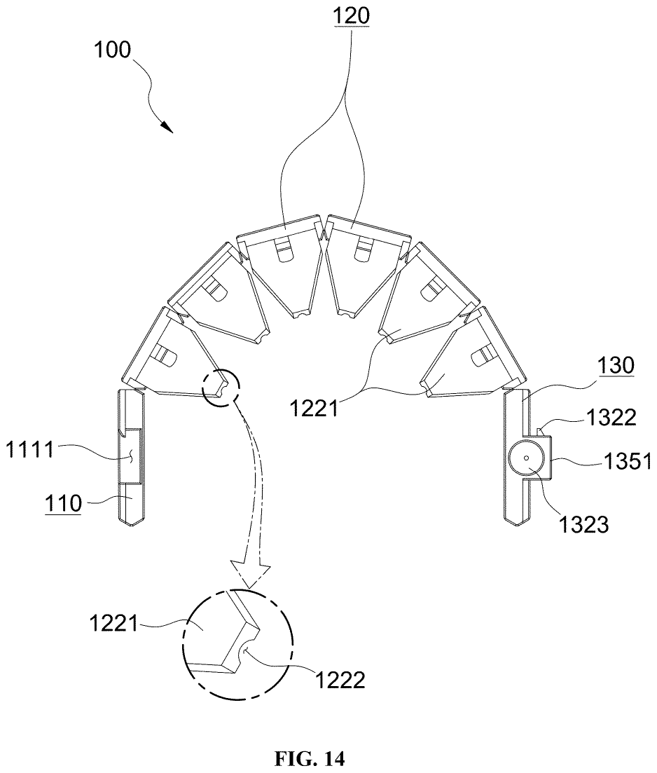

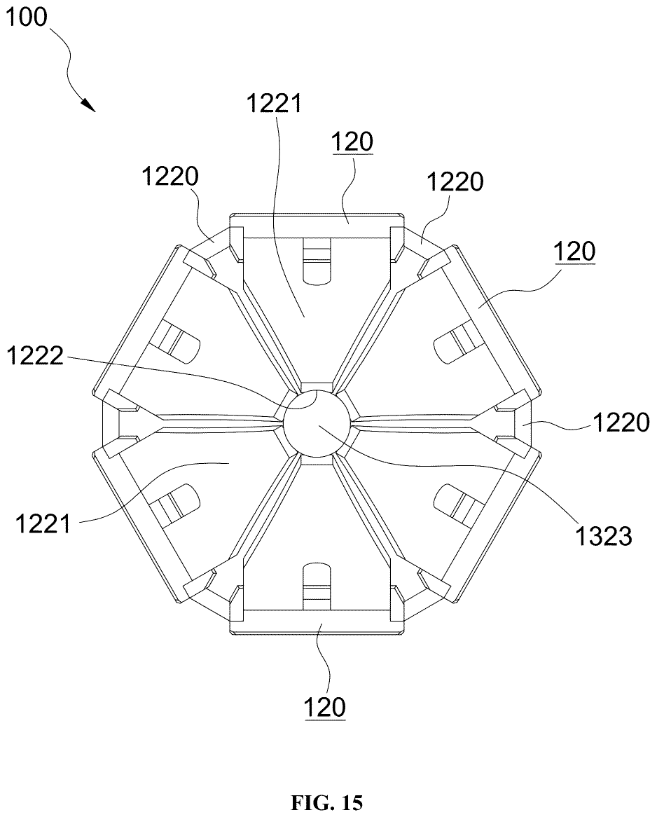

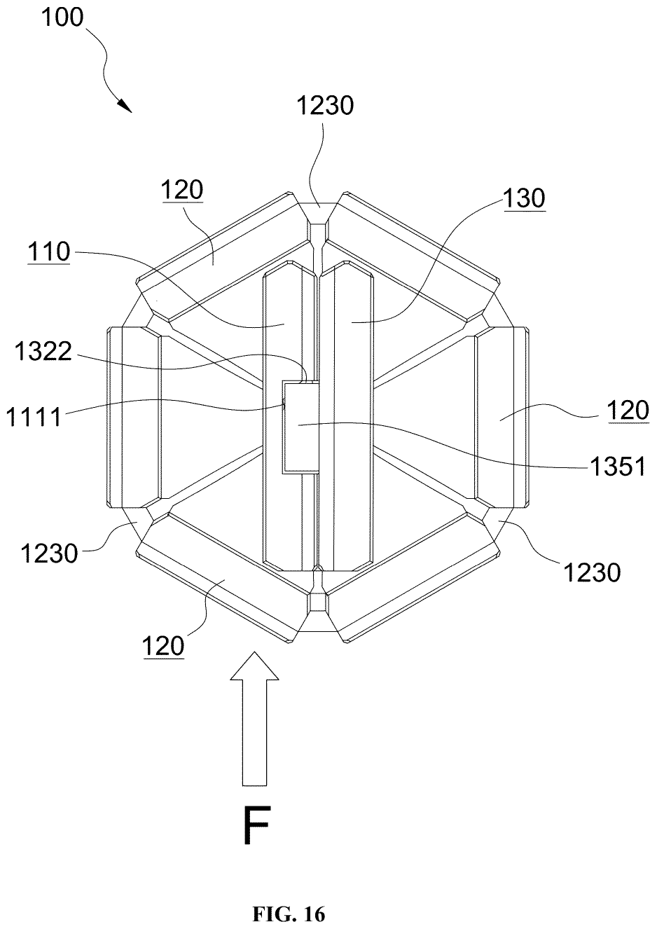

With the pen support 1221 protruding, as shown in FIG. 10, the card-shaped rollable pen 100 is then rolled into a cylindrical shape as depicted in FIGS. 13 and 14, making the six connecting members 120 form a hexagonal column as shown in FIGS. 15 and 16.

At this time, as illustrated in FIG. 3, the elastic protrusions 1232 of the links 123 and the elastic protrusions 1228 of the slide links 1220 elastically compress to make the connecting members 120 contact each other, ensuring the structure remains intact and does not collapse when rolled into a hexagonal column as shown in FIG. 15.

Additionally, it is preferable that the sides at the bottom of the housing 1210 of each connecting member 120 are chamfered at a 60° angle relative to the base of the housing 1210, allowing the chamfered surfaces to touch when the connecting members 120 are rolled together, thereby stably forming a hexagonal shape.

Once the six connecting members 120 are rolled to form a hexagonal column, as shown in FIG. 16, the protruding pen part 1351 of the upper member 130 is inserted and secured into the pen storage groove 1111 of the lower member 110, thus fixing the connecting members 120 in the hexagonal column shape.

At this point, as shown in FIG. 13, a pen part storage groove fixing protrusion 1322 protrudes from one side of the pen part 1351, ensuring that when the pen part 1351 is pressed into the pen storage groove 1111, it remains securely fixed without detaching.

When the connecting members 120 are rolled up, the triangular-shaped pen supports 1221 protruding from them come together at the front of the connecting members to form a hexagonal cone. The ends of the hexagonal cone-shaped pen supports 1221 adhere to the outer surface of the pen 1323, providing stability and preventing the pen from wobbling during writing.

At this stage, it is advisable to form a pen groove 1222 with the same curvature as the diameter of the pen 1323 on the inner surface of the ends of the pen supports 1221, as shown in FIGS. 14 and 15. This configuration more securely fixes the pen 1323 in place, ensuring it does not move.

The invention configured as above is thin enough to be stored in the credit card compartment of a wallet. When needed for writing, the holder 1320 is pushed forward to extend the pen 1323 and the pen supports 1221. The device is then rolled up and the upper member 130 and lower member 110 are connected to transform it into a conventional pen form.

The transformed pen has the length of a credit card and a thickness that is comfortable to hold for writing, resulting in a pleasant writing and handling experience. Additionally, because the cross-section of the transformed pen is hexagonal, it is easy to grip.

After using the pen, applying force in the direction of the arrows as shown in FIG. 16 causes the pen part 1351 of the upper member 130 to detach from the pen storage groove 1111 of the lower member 110. As the pen supports 1221 and the pen 1323 protrude, pushing the exposed holder 1320 backward returns the pen and the pen supports back inside the upper member 130 and the connecting members 120, respectively, transforming back into a card form as the slide links 1220 and links 1230's elastic protrusions 1228 and 1232 straighten.

The embodiment of the invention described involves adjacent members being connectable via slide links and links, allowing them to rotate relative to one another. Although not shown in the drawings, it is also possible to configure adjacent members to be connected via an axis, enabling rotation between them.

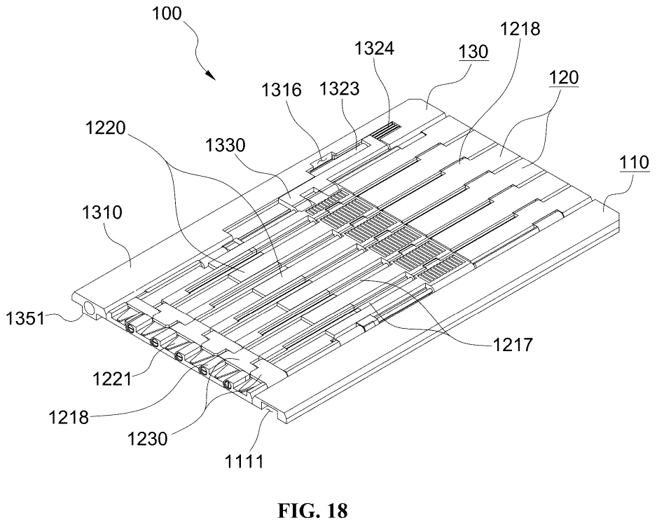

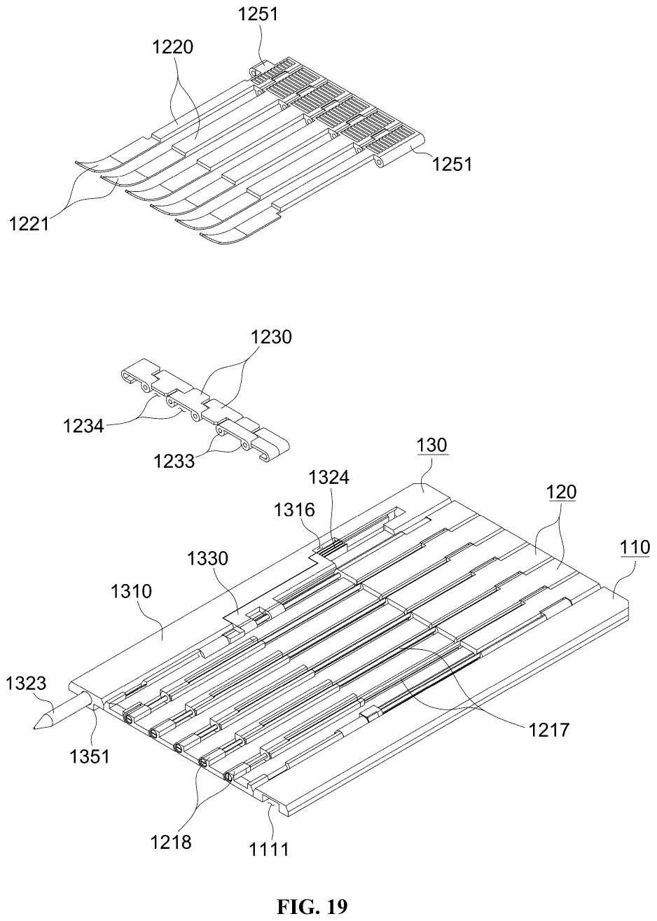

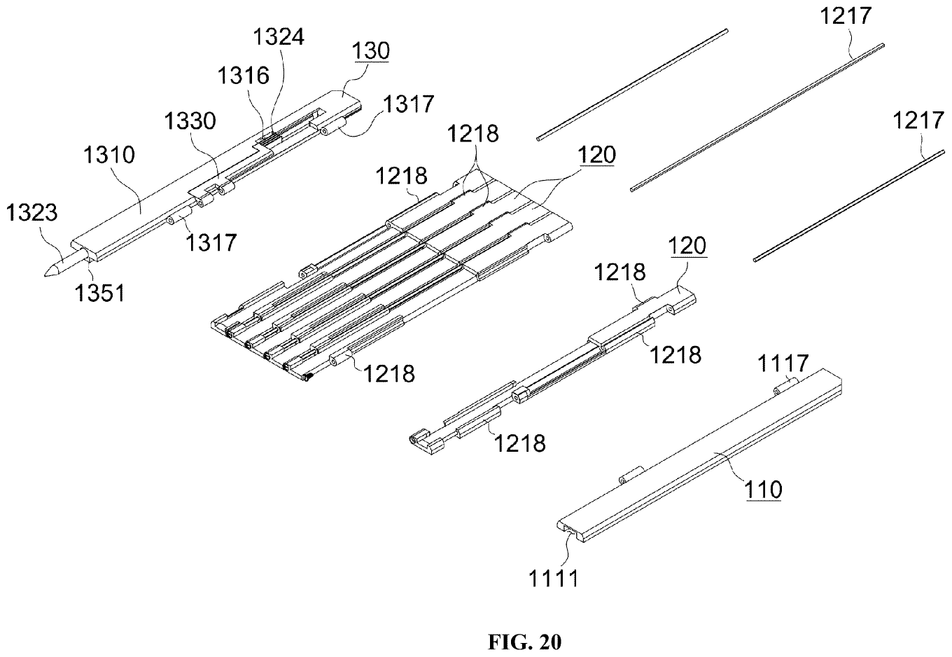

FIG. 18 illustrates a perspective view of a card-shaped rollable pen 100 according to another embodiment of the invention, while FIGS. 19 and 20 each depict an exploded perspective view of the card-shaped rollable pen 100 according to other embodiments of the invention.

Like the previously described embodiment, this other embodiment of the invention consists of an upper member 130, connecting members 120, and a lower member 110.

As shown in FIGS. 19 and 20, each member (110, 120, 130) is connected to adjacent members via an axis (1217).

The upper member 130, as depicted in FIG. 20, is configured to allow the pen 1323 to slide longitudinally within the housing 1310.

At the rear end of the pen 1323, a slide link 1330 and a fixing knob 1324 are attached, enabling the pen 1323 to slide along with the housing 1310; a sleeve 1317 is formed on one side of the housing 1310.

On one side of the upper member 130, six connecting members 120 are attached. As shown in FIG. 20, each connecting member 120 has sleeves 1218 formed on both sides of its body. These sleeves 1218 are aligned on the same axis with the sleeves 1218 of the adjacent connecting members 120, and an axis 1217 is inserted into these sleeves 1218, thereby consecutively connecting the six connecting members 120.

Additionally, as shown in FIGS. 18 and 19, links 1230 and slide links 1220 are coupled to the top of each connecting member 120.

Sleeves 1251 are formed on both sides of the slide link 1220. An axis 1217, which fastens the connecting members 120, is inserted into these sleeves 1251, allowing the slide link 1220 to slide along the axis 1217.

In front of each slide link 1220, an elastically deformable pen support 1221 is formed.

At the front upper part of each connecting member 120, in the direction from which the pen 1323 protrudes, a link 1230 is attached. This link 1230 has sleeves 1233 formed on both sides of its body, into which an axis 1217 that fastens the connecting member 120 is inserted, securing the link 1230 to the connecting member 120.

Below the link 1230, a pen support insertion groove 1234 is formed, into which the pen support 1221 of the slide link 1220 is inserted.

The pen support 1221 is bent or curved at a predetermined angle, as shown in FIG. 19. The bent or curved part of the pen support 1221 inserts into the pen support insertion groove 1234 of the link 1230, causing the bent or curved pen support 1221 to elastically deform and flatten, as depicted in FIG. 18.

The lower member 110, as illustrated in FIG. 20, has a sleeve 1117 formed on one side of its body, and a pen storage groove 1111 formed in the shape of a groove on the lower surface of the body.

The sleeve 1117 is aligned on the same axis as the sleeve 1218 of the connecting member 120, and with the insertion of the axis 1217, it is attached in a manner that allows rotation relative to the connecting member 120.

The other embodiment of the invention, configured as described, is detailed below for the transformation process from a card shape to a pen shape.

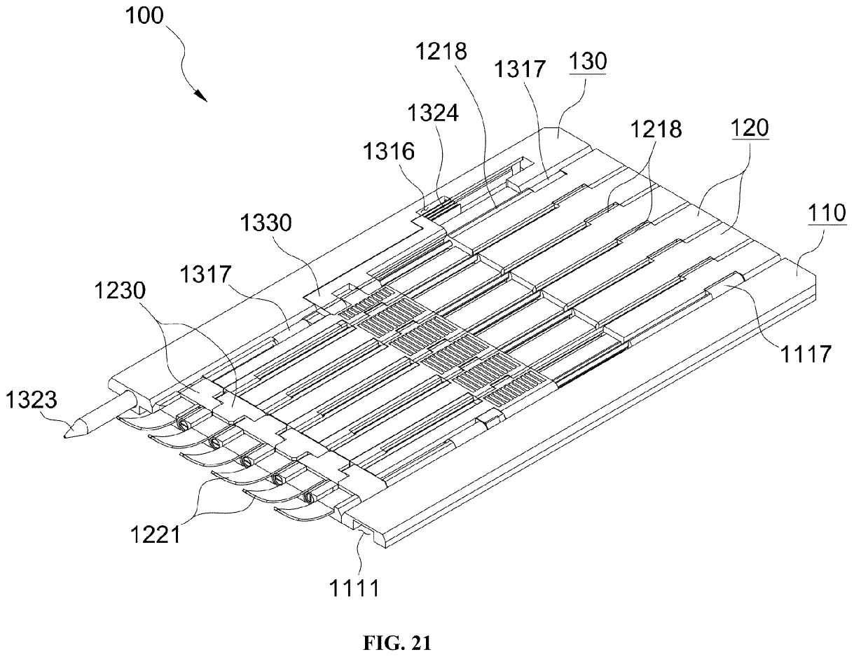

To transform the card-shaped invention into a pen, as shown in FIG. 21, the slide link 1220 of the connecting member 120 is pushed to slide it forward.

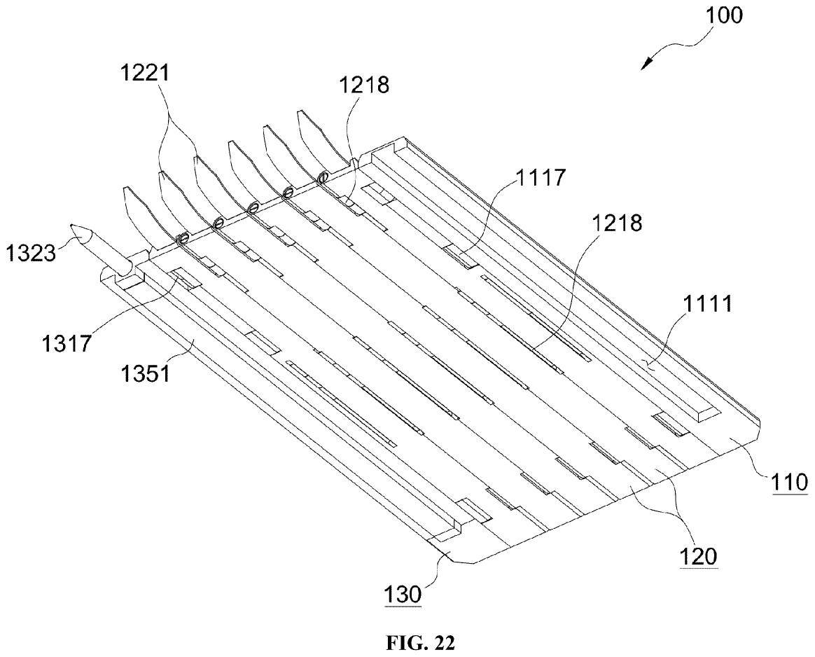

When the slide link 1220 is pushed, as illustrated in FIGS. 21 and 22, the pen support 1221 protrudes forward from the connecting member 120.

Initially, the pen support 1221 is stored in a flattened, elastically deformed state under the pressure of the link 1230 in the pen support insertion groove 1234. As the pen support 1221 protrudes, it escapes the constraint of the link 1230 and elastically restores to an upwardly bent or curved form.

Furthermore, a sleeve (unnumbered) formed on one side of the slide link 1330 of the upper member 130 is aligned on the same axis as the sleeve 1251 of the adjacent connecting member 120, where an axis 1217 is inserted and fastened.

Therefore, when the slide link 1220 of the connecting member 120 slides forward, the slide link 1330 of the upper member 130 also slides in tandem, causing the pen 1323 to protrude forward as depicted in FIGS. 21 and 22.

As the slide link 1330 slides, the fixing knob 1324 located at its rear also moves in sync, positioning itself at one side of a fixing groove 1316.

The fixing knob 1324 is mounted on the slide link 1330 such that it can rotate, and when the fixing knob 1324 is rotated, it inserts into the fixing groove 1316 of the upper member 130.

Once the fixing knob 1324 is inserted into the fixing groove 1316, it prevents the pen 1323 and the pen support 1221 from moving arbitrarily under external forces, thereby securing them in place.

As shown in FIGS. 21 and 22, with the pen 1323 and the pen support 1221 protruded, the card-shaped rollable pen 100 is rolled into a pen shape.

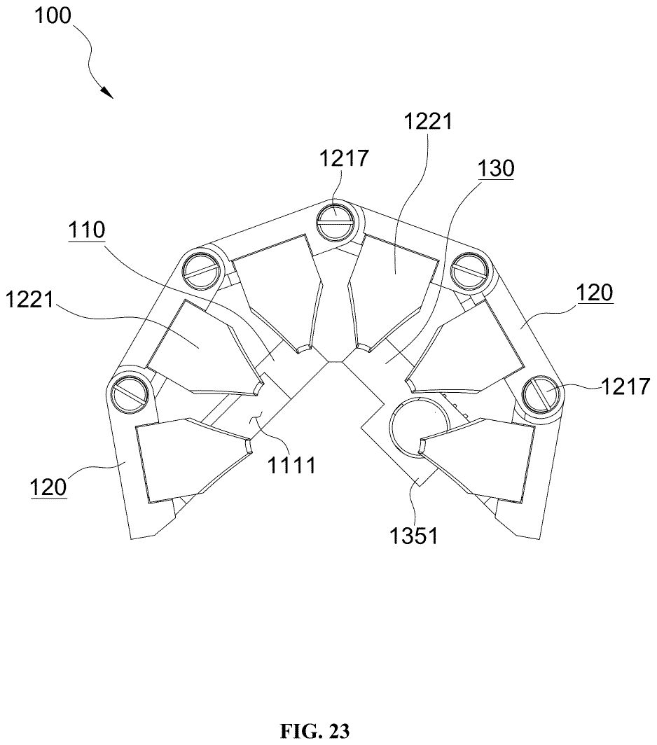

As shown in FIG. 23, each connecting member 120 is rotated around its axis 1217, and the upper member 130 and the lower member 110 are inserted into the rolled pen interior.

When the pen is fully rolled such that the first connecting member 120 and the sixth connecting member 120 touch each other, the bottom surface of the upper member 130 and the bottom surface of the lower member 110 come into contact inside the pen.

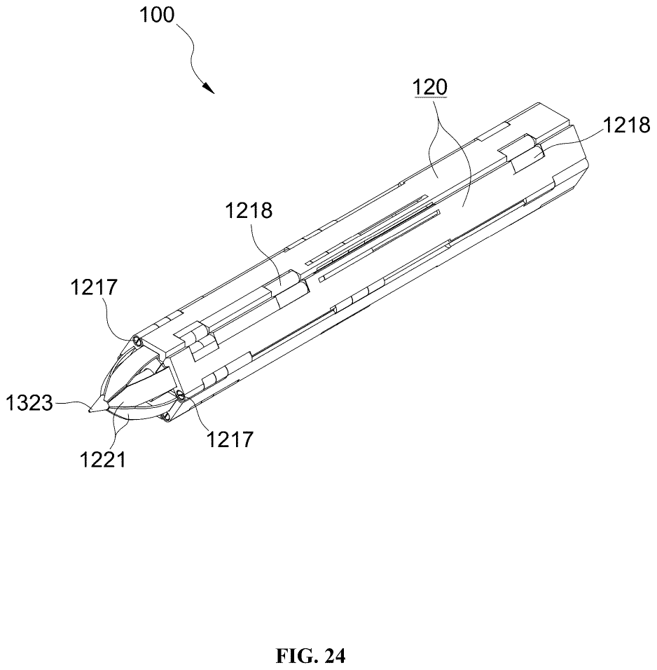

As depicted in FIG. 22, a protruding pen part 1351 is formed on the bottom surface of the upper member 130, and a pen storage groove 1111 in the shape of a groove is formed on the bottom surface of the lower member 110. After rolling the connecting members 120 into a pen shape, inserting the pen part 1351 of the upper member 130 into the pen storage groove 1111 of the lower member 110 secures the structure in a pen shape, as shown in FIG. 24.

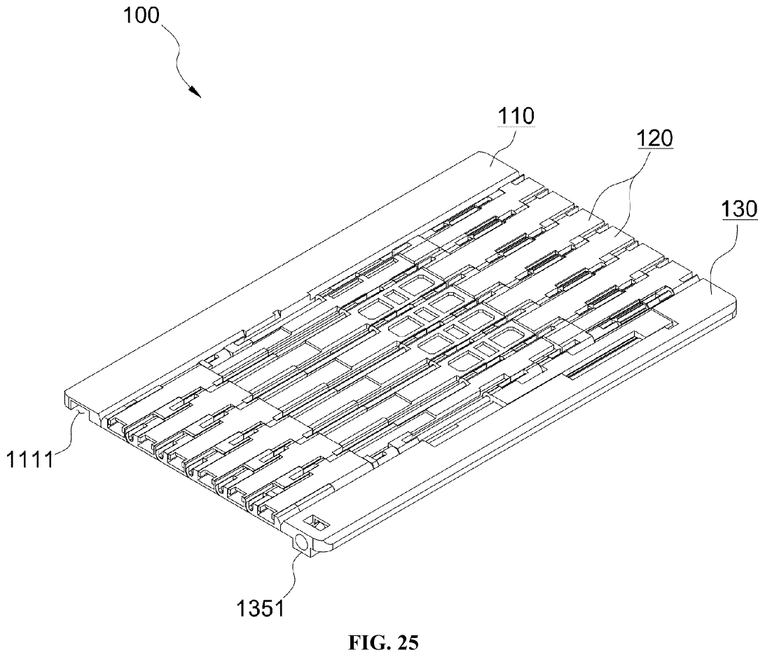

FIG. 25 illustrates a perspective view of a card-shaped rollable pen 100 according to another embodiment of the invention.

This other embodiment of the rollable pen 100, like the previously described embodiments, consists of an upper member 130, a lower member 110, and a prescribed number (preferably six) of connecting members 120 that connect the upper and lower members.

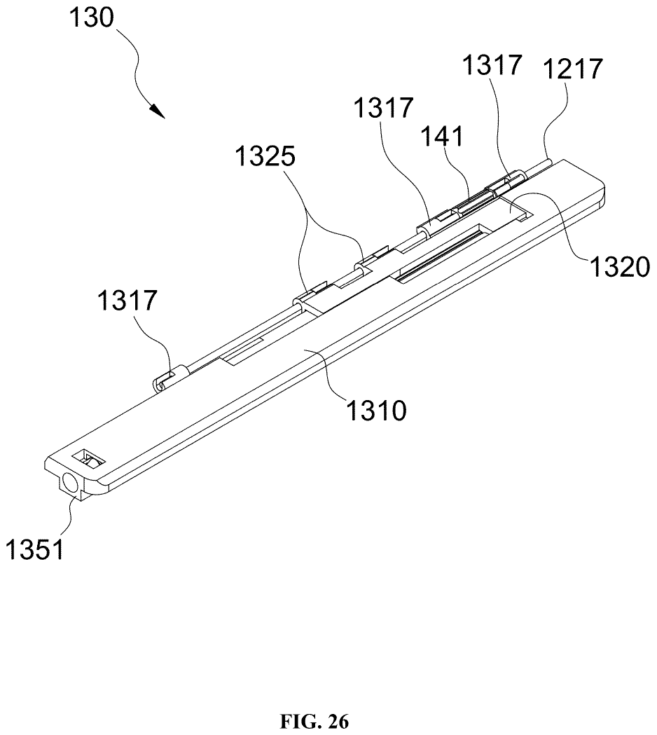

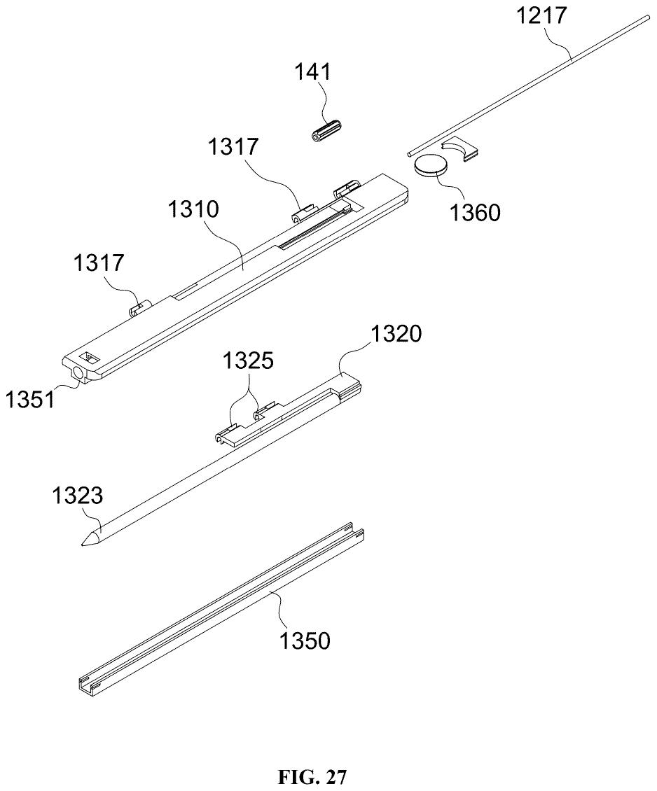

As shown in FIGS. 26 and 27, the upper member 130 comprises a housing 1310, and within this housing 1310, a holder 1320 and a pen 1323 are stored.

On one side of the housing 1310, sleeves 1317 are formed at prescribed intervals, and a holder 1320, which secures the pen 1323, is stored within the body of the housing 1310. When the holder 1320 is stored in the housing 1310, part of the holder 1320 is exposed at the top of the housing 1310, and a pair of sleeves 1325 formed on one side of the holder 1320 is exposed and aligns on the same axis as the sleeves 1317 of the housing 1310.

When an axis 1217 is inserted into the sleeves 1317 of the housing 1310, it simultaneously inserts into both the sleeves 1317 of the housing 1310 and the sleeves 1325 of the holder 1320, thereby securing the holder 1320 within the body of the housing 1310. The holder 1320 is then able to slide along the axis 1217 within the body of the housing 1310.

At the rear of the housing 1310's body, a groove (not shown) is formed where a magnet 1360 is inserted.

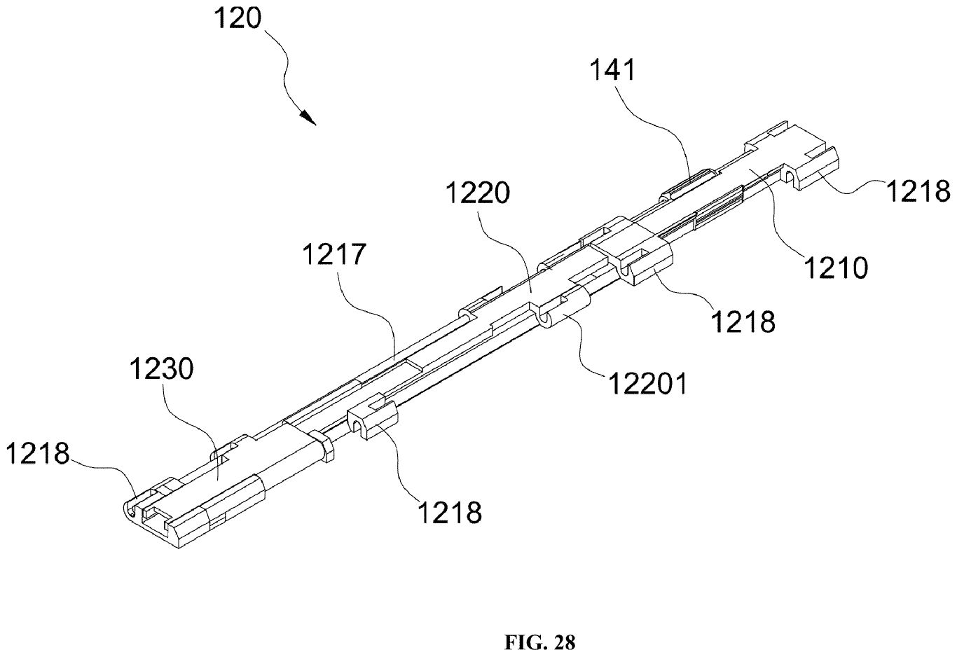

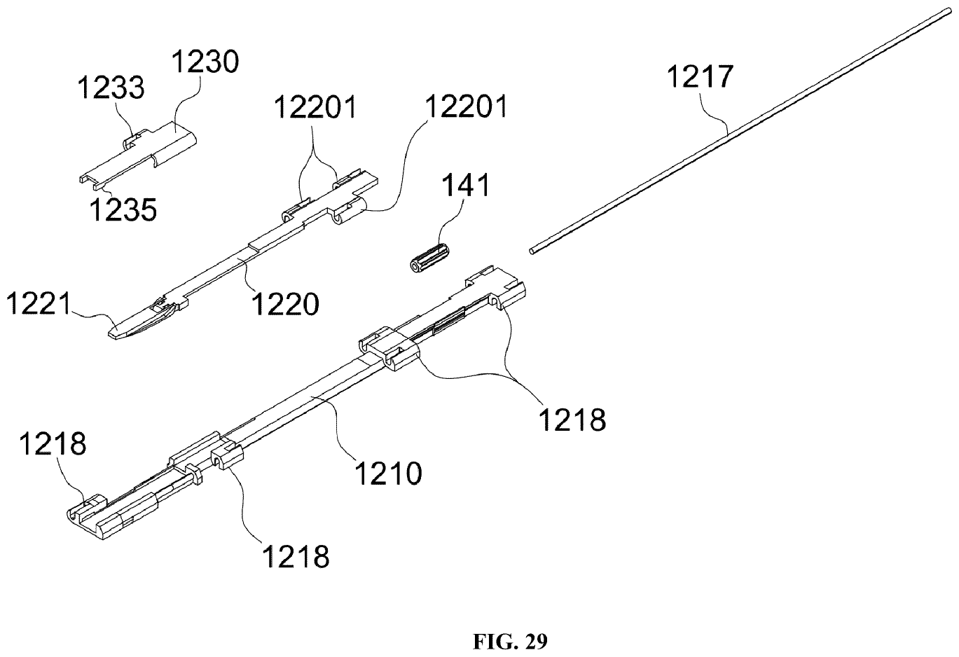

As shown in FIGS. 28 and 29, each connecting member 120 consists of a housing 1210 with sleeves 1218 formed on both sides at prescribed intervals, a slide link 1220 and a pen support 1221 located at the top of the housing 1210, and a link 1230 that covers the top of the pen support 1221.

Sleeves 1218 are formed on both sides of the slide link 1220's body, and the pen support 1221 is hinged at the body's tip and adheres to the upper surface of the housing 1210. The link 1230, which has sleeves 1233 formed on both sides, covers the top of the pen support 1221.

The sleeves 1218 on both sides of housing 1210, sleeves 12201 on both sides of slide link 1220, and sleeves 1233 on both sides of link 1230 are all aligned along the same axis. When an axis 1217 is inserted into the sleeves 1218 of housing 1210, it also inserts through the sleeves 12201 of slide link 1220 and sleeves 1233 of link 1230, thereby fastening the housing 1210, slide link 1220, and link 1230 together.

The slide link 1220 is then able to slide along axis 1217 within housing 1210, causing the pen support 1221 to either protrude from or retract into housing 1210 as the slide link 1220 moves.

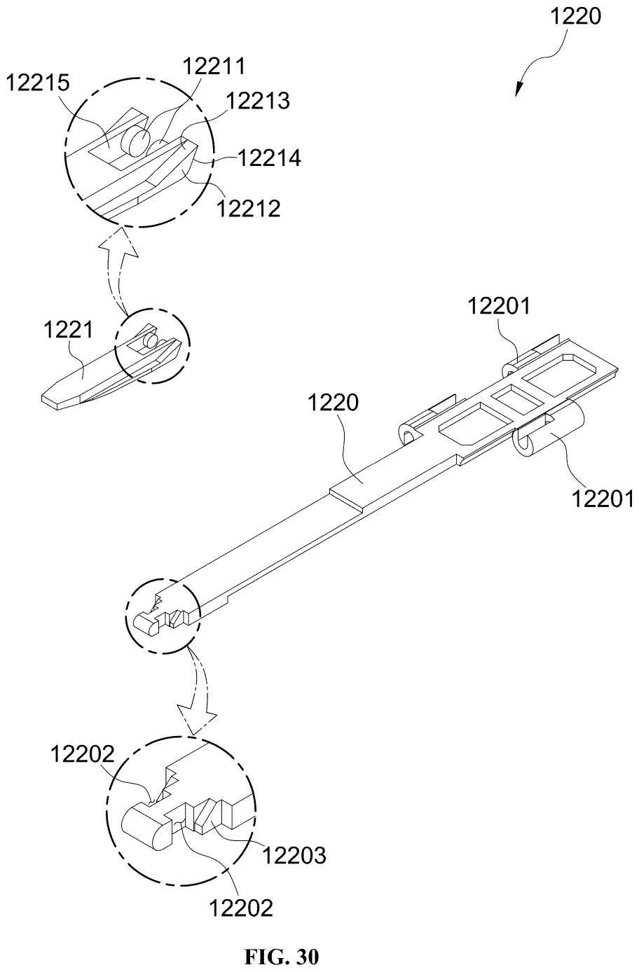

The pen support 1221, hinged at the tip of slide link 1220 as shown in FIG. 30, has extension parts 12215 formed at its rear end, extending backward. A hinge 12211 protrudes on the inner side of these extension parts 12215, while side projections 12212 protrude on the outer side.

These side projections 12212 extend in a triangular shape with an inclined first surface 12213 and a second surface 12214 on the front and back, respectively, projecting laterally from the extension parts 1221.

Hinge grooves 12202 are formed on both sides of the tip of slide link 1220. The hinge 12211 of pen support 1221 inserts into the hinge grooves 12202 of slide link 1220, allowing the pen support 1221 to rotate about hinge 12211 within slide link 1220.

As depicted in FIG. 30, stoppers 12203 with inclined surfaces are formed on both sides of slide link 1220, at the rear position of hinge grooves 12202. These stoppers 12203 limit the rotation angle of pen support 1221, preventing it from rotating beyond a certain point.

As slide link 1220 moves within connecting member 120, pen support 1221 either protrudes from or retracts into housing 1210. When pen support 1221 protrudes, it rotates and bends. Conversely, when pen support 1221 retracts back into housing 1210, it flattens out.

For this purpose, as illustrated in FIGS. 29, 30, and 31, a guide protrusion 1235 is positioned on the underside of the front end of link 1230 that covers the pen support 1221 within connecting member 120.

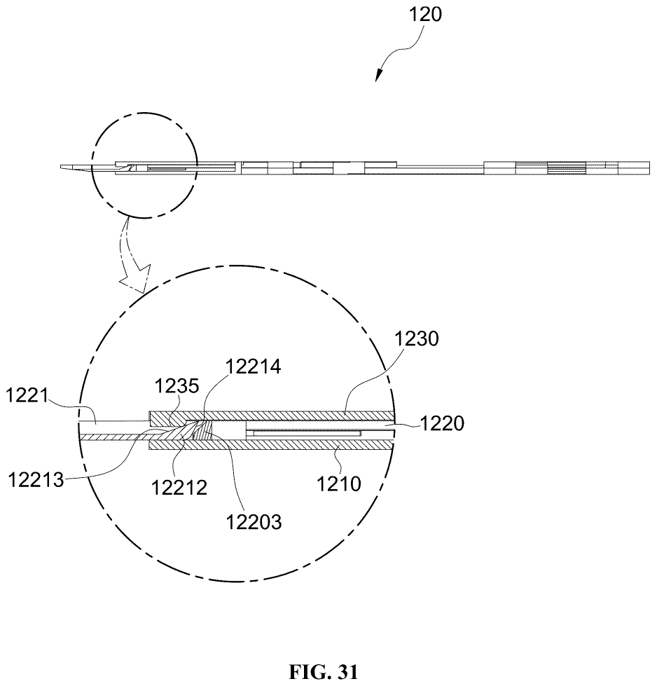

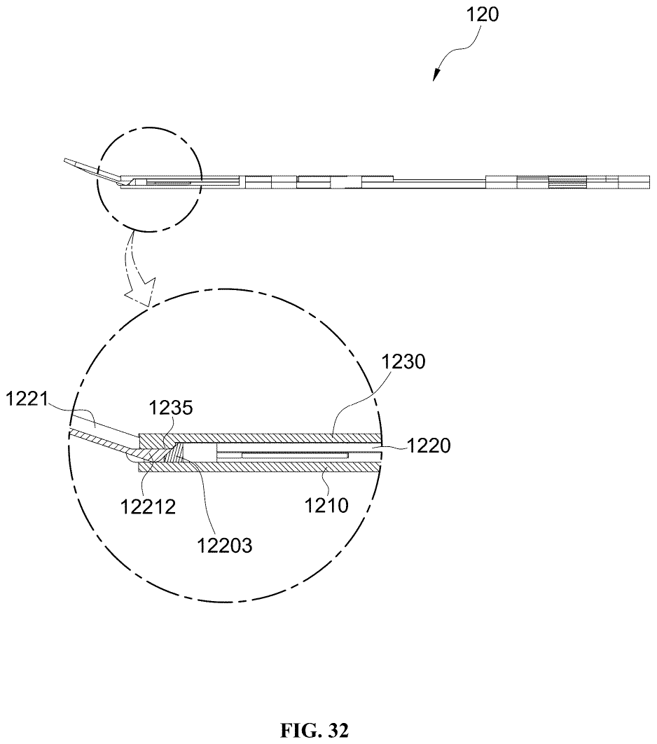

FIGS. 31 and 32 sequentially display sectional views of a connecting member from another embodiment of the invention, showing the process of the pen support 1221 protruding and rotating.

As the slide link 1220 in the connecting member 120 slides and causes the pen support 1221 to protrude, the first surface 12213 of the side protrusion 12212 of pen support 1221 contacts the guide protrusion 1235 of link 1230. As slide link 1220 continues to slide, pen support 1221 rotates about its hinge 12211, as shown in FIG. 30, turning upwards as illustrated in FIG. 32.

The rotation of pen support 1221 stops when the second surface 12214 of side protrusion 12212 contacts the stopper 12203 of slide link 1220.

At this point, the side protrusion 12212 simultaneously contacts both the guide protrusion 1235 of link 1230 and the stopper 12203 of slide link 1220, securing pen support 1221 in a rotated position.

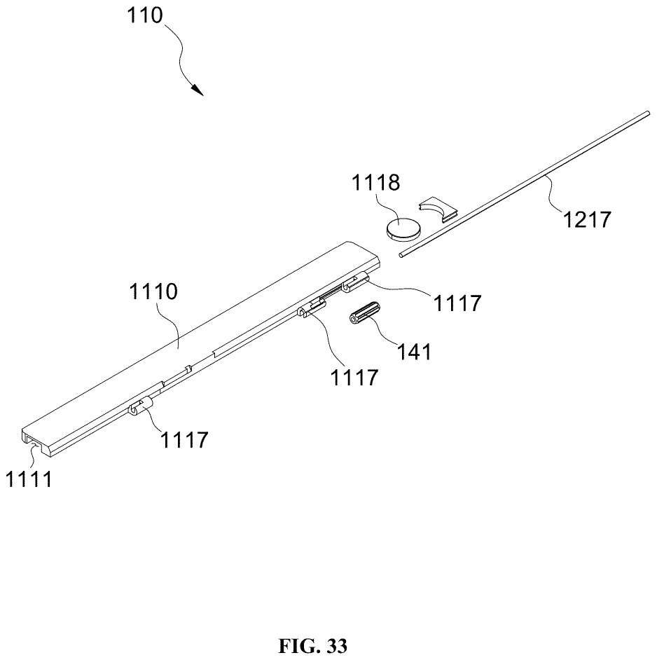

As shown in FIG. 33, the lower member 110 features sleeves 1117 formed at specified intervals on one side of housing 1110, a pen storage groove 1111 formed in the shape of a groove on the lower part of the housing 1110, and a magnet 1360 inserted into a groove (not shown) formed at the rear of the housing 1110.

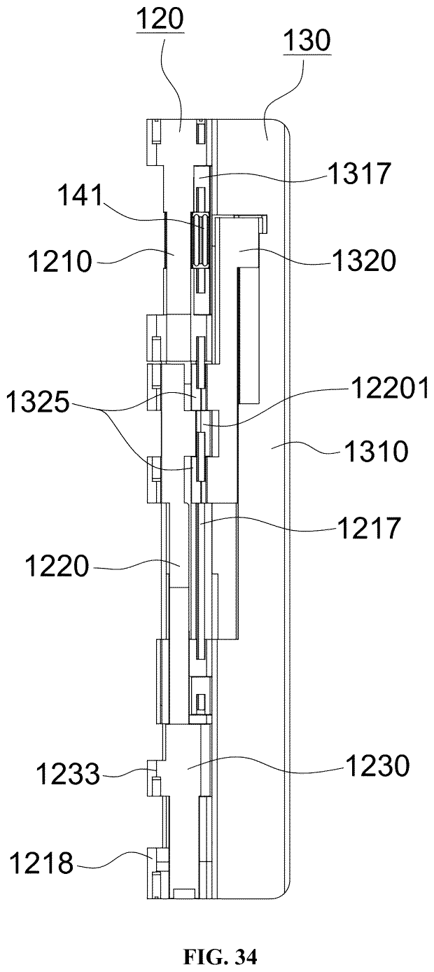

In this embodiment of the rollable pen 100, the lower member 110, connecting member 120, and upper member 130 are connected as described. As shown in FIG. 34, the sleeves 1317 of the upper member 130 and the sleeves 1218 of the connecting member 120 are aligned on the same axis, and an axis 1217 is inserted through these sleeves to secure them.

The sleeve 2201 formed on one side of the slide link 1220 of the connecting member 120 is inserted between the sleeves 1325 of holder 1320, closely aligning along the direction of axis 1217, thereby synchronizing the slide movements of the holder 1320 with the slide link 1220 of the connecting member 120.

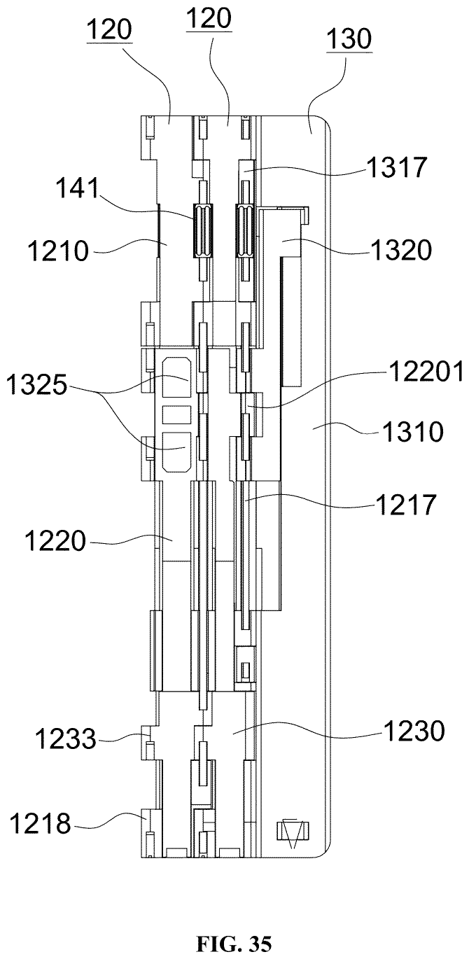

As shown in FIG. 35, the sleeves 1218 of one connecting member 120 are aligned on the same axis with the sleeves 1218 of another connecting member 120, and an axis 1217 is inserted into these sleeves to secure them.

At this time, the sleeve 12201 formed on the opposite side of the slide link 1220 in one connecting member 120 closely aligns along the axis 1217 with the sleeve 12201 formed on one side of the slide link 1220 in another connecting member 120, thus synchronizing the sliding movements of the slide links 1220 across the connecting members 120.

Using this attachment method, a prescribed number of connecting members 120 (preferably six) are consecutively connected.

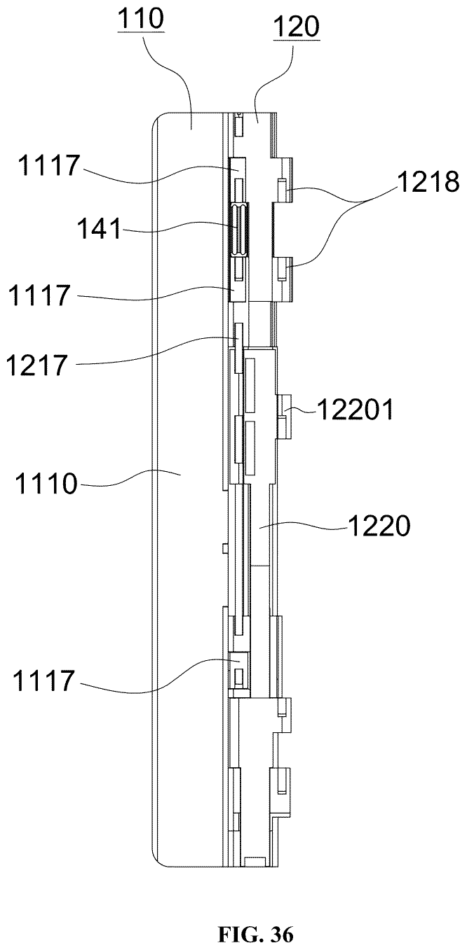

Similarly, as depicted in FIG. 36, the sleeve 1117 of the lower member 110 and the sleeves 1218 of the connecting member 120 are positioned on the same axis and an axis 1217 is inserted through these sleeves to fasten them.

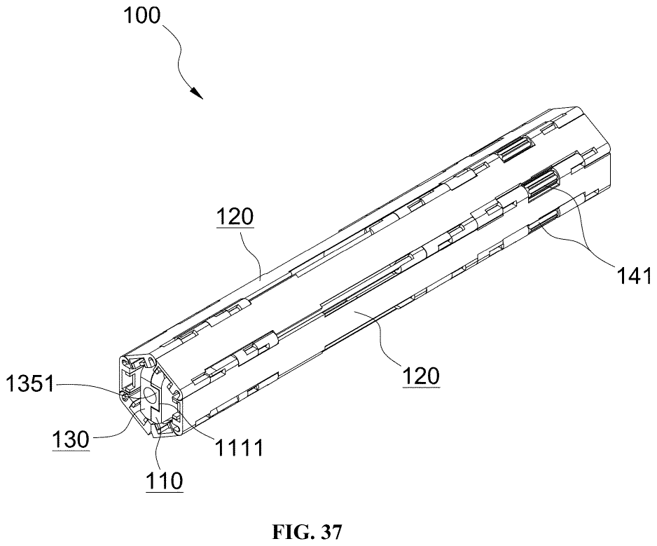

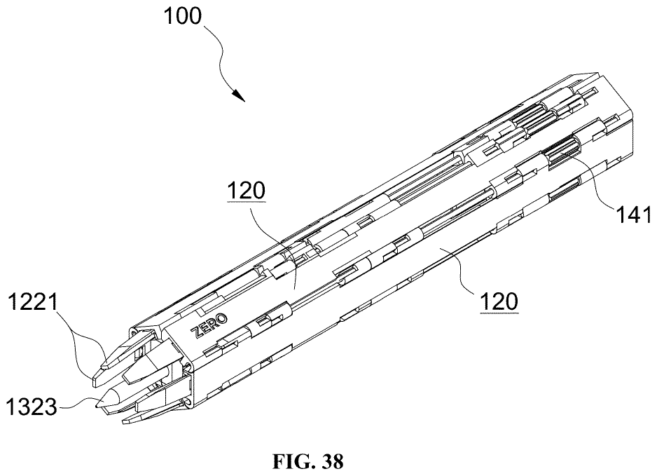

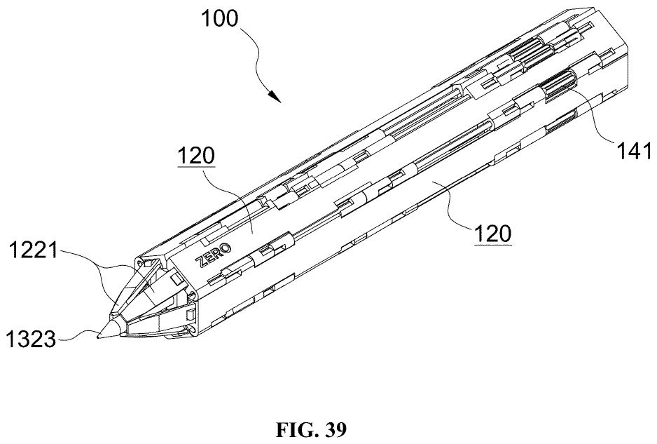

Once the upper member 130, six connecting members 120, and the lower member 110 are connected, the rollable pen 100 forms into a card shape as illustrated in FIG. 25. This allows for easy storage in the credit card compartment of a wallet or in a pocket. When needed as a pen, the rollable pen 100 is rolled into a pen shape as shown in FIG. 37.

By rolling the six connecting members 120 into a hexagonal column shape, and inserting the protruding pen part 1351 of the upper member 130 into the pen storage groove 1111 formed in the lower member 110, the upper and lower members are secured together. This secures the connecting members 120 in a hexagonal shape, stabilizing the structure.

At this point, the upper member 130 and the lower member 110 are further securely fastened together by the magnetic attraction between a magnet 1360 stored inside the housing 1310 of the upper member and a magnet 1118 stored inside the housing 1110 of the lower member.

During the transformation of the rollable pen 100 from a card shape to a pen shape, and vice versa, the upper member 130, connecting members 120, and lower member 110 rotate around the axis 1217. To ensure precise angular positioning and maintain the correct form during transformation, it is advisable to insert a hexagonally shaped latch 141 into each axis 1217. This latch 141 contacts the side of the housings of the components, allowing the connecting members 120 to stop at precise angles, providing a distinct sense during the transformation process.

The latch 141 is preferably molded from Polyoxymethylene (POM), which is known for its dimensional stability, wear resistance, and mechanical strength, ensuring durability and reliability in the locking mechanism.

After transforming the rollable pen 100 from a card shape to a pen shape, as depicted in FIG. 37, pushing the holder 1320 of the upper member 130 causes it to slide, and as shown in FIG. 38, the pen 1323 protrudes from the upper member 130.

As the holder 1320 in the upper member 130 and the slide link 1220 in the connecting member 120 are interconnected, the pen 1323 and the pen support 1221 also protrude together as illustrated in FIG. 38.

As the pen support 1221 protrudes and rotates, as shown in FIGS. 31 and 32, the rotating pen support 1221 radially embraces the pen 1323, as depicted in FIG. 39. This supports the pen 1323 firmly during writing, preventing any wobbling or instability.

While the embodiments of the invention described involve connecting six members 120 to form a hexagonal cross-section pen, it is also possible to connect eight connecting members 120 to configure a pen with an octagonal cross-section, offering different aesthetic and ergonomic properties.

The invention configured as described above allows for convenient storage in a wallet in card form. When needed, the card-shaped pen can be easily rolled into a conventional pen shape for use.

Moreover, even when transformed into a regular pen shape by rolling, the body of the pen remains stable without shaking, providing a writing experience comparable to that of a traditional pen.

The foregoing examples have been described to illustrate the technical ideas of the invention.

It is apparent to those skilled in the art that various modifications and variations can be made to the embodiments of the invention described herein without departing from the spirit or scope of the invention.

Furthermore, it is evident that those skilled in the art may make various changes or modifications to the inventive concepts contained herein without departing from the scope of the invention, even if these variations or modifications are not explicitly depicted or described. These variations are still regarded as within the ambit of the invention.

The embodiments described with reference to the accompanying drawings are intended for illustrative purposes only and are not intended to limit the scope of the invention.

### INDUSTRIAL APPLICABILITY

This invention can be utilized as a portable pen.

What is claimed is:

1. A rollable pen comprising:
an upper member in which a pen is stored to allow slide movement;
a predetermined number of connecting members continuously attached in parallel on one side of the upper member;
a lower member attached in parallel to the side ends of the continuously connected connecting members; and
rotational fastening means for connecting each of the members such that they can rotate at a predetermined angle relative to each adjacent member,
wherein each of the members forms a card shape when rolled up, the connecting members form a polygonal column, and the upper and lower members are fastened inside the polygonal column by the fastening means, allowing the pen to protrude and transform from a card form to a pen form,
the fastening means for securing the upper and lower members within the polygonal column comprise:
a space within which a holder is stored, a protruding pen part from the upper member, and a pen storage groove formed in the lower member as a groove, wherein the pen part is configured to insert and secure into the pen storage groove.

2. The rollable pen according to claim 1, further comprising:
a slide link attached to each connecting member to enable longitudinal sliding movement;
a triangularly shaped pen support formed at the end of the slide link;
wherein the pen support protrudes in coordination with the pen and contacts the pen radially to support the pen.

3. The rollable pen according to claim 2, wherein:
the surface of the pen support that contacts the pen is formed with a groove-shaped pen groove.

4. The rollable pen according to claim 2, wherein:
the rotational fastening means includes sleeves formed on the sides of each member, with the sleeve of one member and the sleeve of an adjacent member positioned on the same axis,
an axis is inserted into the sleeves to rotatably fasten the members.

5. The rollable pen according to claim 1 further comprising:
a slide link attached to each connecting member to enable longitudinal sliding movement, and a triangularly shaped pen support formed at the end of the slide link, wherein the pen support protrudes in coordination with the pen and contacts the pen radially to support the pen,
wherein the rotational fastening means include sleeves formed on the sides of each member, with the sleeve of one member and the sleeve of an adjacent member positioned on the same axis, and an axis is inserted into the sleeves to rotatably fasten the members, and the axis is inserted into a sleeve formed on the side of the slide link to guide its sliding movement.

6-13. (canceled)
